(19) United States
(12) Patent Application Publication
(10) Pub. No.: US 2026/0368854 A1
(43) Pub. Date: Nov. 19, 2026

(54) Metasurface Feature Detection and Related Methods

(71) Applicants: Gregory Forcherio, Crane, IN (US); VANDERBILT UNIVERSITY, Nashville, TN (US)

(72) Inventors: Jason G. VALENTINE, Nashville, TN (US); Brandon SWARTZ, Nashville, TN (US); Gregory FORCHERIO, Crane, IN (US); Hanyu ZHENG, Nashville, TN (US)

(21) Appl. No.: 18/652,383

(22) Filed: May 1, 2024

Related U.S. Application Data
(60) Provisional application No. 63/499,285, filed on May 1, 2023.

(51) Int. Cl. G06T 5/50; G02B 13/14; G06T 7/13

(52) U.S. Cl. CPC G06T 5/50; G02B 13/14; G06T 7/13; G06T 2207/20084; G06T 2207/20224

(57) ABSTRACT

A device may image an object through a first optic to obtain a first image, wherein the first optic comprises a first refractive lens. A device may image the object through a second optic to obtain a second image, wherein the second optic comprises a second refractive lens and a metasurface. A device may subtract the first image and the second image to obtain a feature-encoded image.

### CROSS-REFERENCE TO RELATED APPLICATIONS

This application claims the benefit of U.S. provisional patent application No. 63/499,285, filed on May 1, 2023, and titled “BROADBAND INCOHERENT LWIR METASURFACE OPTICAL EDGE DETECTION,” the disclosure of which is expressly incorporated herein by reference in its entirety.

### STATEMENT REGARDING FEDERALLY FUNDED RESEARCH

This invention was made with government support under grant number N00014-21-12468 awarded by the Office of Naval Research. The government has certain rights in the invention.

### BACKGROUND

Convolutional neural networks (CNNs) are widely used in computer vision for image segmentation and classification, owing to their high accuracy and versatility (1). Increasing the complexity of a CNN via adding layers or channels generally improves performance but comes at the expense of increased power consumption and calculation time (2), as well as increases in system size and weight, putting practical performance limits on resource-constrained systems (3). Although network architectures (2) and hardware accelerators (3) have gradually improved in recent years, the imaging systems in computer vision still have a largely untapped potential for improving performance and efficiency of the computational tasks. One avenue for improvement is to off-load low-level feature encoding operations, such as edge detection, into an optical front-end (4). Off-loading these operations, which are typically carried out by the first layers of a CNN (1, 5), into an analog optical system could facilitate faster and more energy efficient CNNs without sacrificing accuracy. This necessitate the development of new hardware and software solutions as the demands on machine vision systems continue to grow.

### SUMMARY

In some aspects, the techniques described herein relate to a method for optical edge detection including: imaging an object through a first optic to obtain a first image, wherein the first optic includes a first refractive lens; imaging the object through a second optic to obtain a second image, wherein the second optic includes a second refractive lens and a metasurface; and subtracting the first image and the second image to obtain a feature-encoded image.

In some aspects, the first optic is configured to form positive components of a derivative kernel, and wherein the second optic is configured to form negative components of the derivative kernel.

In some aspects, the derivative kernel is a Laplacian kernel.

In some aspects, the metasurface includes a plurality of sub-wavelength structures.

In some aspects, the method further includes optimizing the plurality of sub-wavelength structures using an inverse design process.

In some aspects, the method further includes inputting the feature-encoded image into an artificial neural network (ANN).

In some aspects, the ANN is a deep neural network.

In some aspects, the step of imaging the object includes capturing incoherent radiation reflected from or emitted by the object.

In some aspects, the incoherent radiation is in the long-wave infrared (LWIR) band.

In some aspects, the techniques described herein relate to an optical edge detection system including: a first optic including a first refractive lens; a second optic including a second refractive lens and a metasurface; an imaging device configured to capture a first image through the first optic and a second image through the second optic; at least one processor operably coupled to the imaging device; and at least one memory operably coupled to the at least one processor, the at least one memory having computer-executable instructions stored thereon that, when executed by the at least one processor, cause the at least one processor to: receive, from the imaging device, the first image and the second image; and subtract the first image and the second image to obtain a feature-encoded image.

In some aspects, the first optic is configured to form positive components of a derivative kernel, and wherein the second optic is configured to form negative components of the derivative kernel.

In some aspects, the derivative kernel is a Laplacian kernel.

In some aspects, the techniques described herein relate to a method for optical edge detection including: imaging an object through an optic to obtain a plurality of images, wherein the optic includes a refractive lens and a metasurface configured for polarization multiplexing, wherein the optic is configured to form positive components and negative components of a derivative kernel; and subtracting a first image and a second image of the plurality of images to obtain a feature-encoded image.

In some aspects, the derivative kernel is a Laplacian kernel.

In some aspects, the plurality of images are obtained simultaneously.

In some aspects, the metasurface includes a plurality of sub-wavelength structures.

In some aspects, the method further includes optimizing the plurality of sub-wavelength structures using an inverse design process.

In some aspects, the step of imaging the object includes capturing incoherent radiation reflected from or emitted by the object.

In some aspects, the techniques described herein relate to a method, wherein the incoherent radiation is in the long-wave infrared (LWIR) band.

In some aspects, the method further includes inputting the feature-encoded image into an artificial neural network (ANN).

In some aspects, the techniques described herein relate to an optical edge detection system including: an optic including a refractive lens and a metasurface configured for polarization multiplexing, wherein the optic is configured to form positive components and negative components of a derivative kernel; an imaging device configured to capture a plurality of images through the optic; at least one processor operably coupled to the imaging device; and at least one memory operably coupled to the at least one processor, the at least one memory having computer-executable instructions stored thereon that, when executed by the at least one processor, cause the at least one processor to: receive, from the imaging device, the plurality of images; and subtract a first image and a second image of the plurality of images to obtain a feature-encoded image.

In some aspects, the derivative kernel is a Laplacian kernel.

In some aspects, the imaging device is a polarimetry-enabled device.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates the principal of bipolar optoelectronic edge detection from incoherent illumination according to an implementation described herein.

FIG. 2 is a flowchart illustrating an example feature detection method using a two-aperture design according to implementations described herein.

FIG. 3 is a flowchart illustrating an example feature detection method using a single aperture design according to implementations described herein.

FIG. 4 is an example computing device.

FIGS. 5A-5E illustrate Metasurface Design. FIGS. 5A and 5B illustrate phase and transmittance maps of polarization insensitive meta-atom library, respectively. FIG. 5C is a process diagram for inverse design method. FIGS. 5D and 5E illustrates simulated broadband combined and component PSFs for the (FIG. 5D) inversely designed and (FIG. 5E) spiral phase metasurfaces.

FIGS. 6A-6H illustrate comparison of results between inverse design metasurface (top row) and spiral phase metasurface (bottom row). FIGS. 6A and 6B are images of fabricated metasurfaces; (inset) SEM images of region on metasurface, 10 μm scale bars. FIGS. 6C and 6D are experimental edge images of blackbody spoke target at 315 K. FIGS. 6E-6H are edge images of 0.104 cy/mrad bar target at (FIGS. 6E, 6F) 2 K and (FIGS. 6G, 6H) 10 K temperature differential.

FIGS. 7A-7I illustrate demonstration of inverse design metasurface for edge encoding of real world scenes. FIG. 7A is an LWIR image of tower. FIG. 7B is an experimental edge image corresponding to FIG. 7A. FIG. 7C illustrates edge locations determined from zero-crossing in FIG. 7B with brightness scaled by edge strength. FIGS. 7D-7F are zoomed in view of FIGS. 7A-7C for region marked in the box of FIG. 7A. FIGS. 7G-7I are edge images of (FIG. 7G) car near building entrance, (FIG. 7H) stadium seats, and (FIG. 7I) overlapping buildings.

FIGS. 8A-8H illustrate results for polarization multiplexing metasurface. FIGS. 8A and 8B illustrate phase and transmittance of polarization sensitive meta-atom library at the center wavelength (10.5 μm), respectively; (inset) SEM images of region on metasurface, 2 μm scale bar. FIGS. 8C and 8D are phase profiles of inversely designed metasurface at center wavelength for x- and y-polarized light; insets show PSFs for corresponding polarization. FIGS. 8E and 8F are images of 0.1 cy/mrad bar target at 350 K for x- and y-polarization. FIG. 8G illustrates effective broadband, bipolar PSF. FIG. 8H is an edge image synthesized from subtraction of the images in FIGS. 8F and 8G.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “about” or “approximately” when referring to a measurable value such as an amount, a percentage, and the like, is meant to encompass variations of ±20%, ±10%, ±5%, or ±1% from the measurable value.

As used herein, the term “metasurface” refers to a thin, artificially structured surface that can manipulate electromagnetic waves such as light in unique ways. For example, a metasurface has a plurality of subwavelength structures, typically much smaller than the wavelength of the waves it interacts with. The subwavelength structures are arranged in a specific pattern to control the properties of light passing through or reflecting off the surface. As non-limiting examples, a metasurface can manipulate properties including, but not limited to, polarization, wavelength, and/or angle of incidence of light passing through or reflecting off the surface.

As used herein, the term “incoherent radiation” refers to radiation including waves with random phase relationships. The waves in incoherent radiation therefore do not maintain a consistent alignment of peaks and troughs. Accordingly, incoherent radiation does not produce a well-defined interference pattern. Sources of incoherent radiation include, but are not limited to, light such as sunlight and artificial light sources such as incandescent bulbs, light emitting diodes (LEDs), and compact fluorescent lamp (CFL) bulbs.

As used herein, the term “coherent radiation” refers to radiation including waves that have a fixed phase relationship with each other. The waves in coherent radiation are in sync, meaning their peaks and troughs align perfectly. Accordingly, coherent radiation exhibits interference phenomena such as diffraction and interference patterns, where waves reinforce or cancel each other out. Sources of coherent radiation include, but are not limited to, lasers.

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that enables a machine to automatically discover representations needed for feature detection, prediction, classification, etc. using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or target) during training with both labeled and unlabeled data.

The prevalence of computer vision systems necessitates hardware-based approaches to relieve the high computational demand of deep neural networks in resource-limited applications. One solution is to offload low-level image feature extraction, such as edge detection, from the digital network to the analog imaging system. To that end, the systems and methods described herein provide for incoherent, broadband, low-noise optical edge detection of real-world scenes by combining the wavefront shaping of a metasurface with a refractive lens. An inverse design approach is used to optimize the metasurface for Laplacian-based edge detection across the 7.5-13.5 μm long-wave infrared (LWIR) imaging band, allowing for facile integration with uncooled microbolometer-based LWIR imagers to encode edge information. A polarization multiplexed approach leveraging a birefringent metasurface is also demonstrated as a single-aperture implementation. The systems and methods described herein can be applied to improve computer vision capabilities of resource constrained systems by leveraging optical preprocessing to alleviate the computational requirements for high accuracy image segmentation and classification.

Machine learning technologies have rapidly developed in recent years at least in part due to the availability of large training dataset and advances in computing hardware. With these advancements, however, the complexity of machine learning models has increased, which results in increases in computing resources and/or energy costs. These issues are problematic for computer vision, particularly computer vision for autonomous systems where the imaging device and processor must have small size, weight, and power consumption for on-board processing while still maintaining low latency, high accuracy, and highly robust operation. The systems and methods described herein provide solutions for these issues. For example, the systems and methods described herein include the combination of a refractive lens and a wavefront shaping metasurface, which facilitates incoherent, broadband, low-noise feature detection. In other words, the combination of the refractive lens and metasurface acts as a front-end, which optically implement convolutional operations, of a system including an artificial neural network (ANN), while the ANN acts as a digital back-end. The systems and methods described herein therefore facilitate the off-load of computationally expensive convolution operations to high-speed and low-power optics.

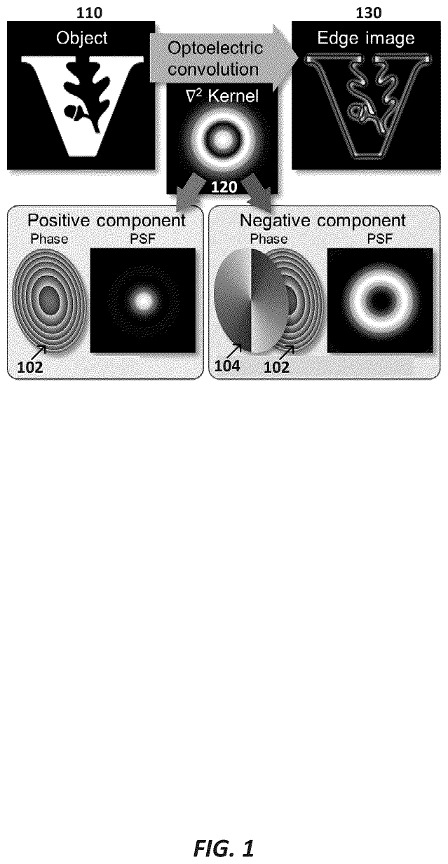

Referring now to FIG. 1, example systems for feature detection are described. In some implementations, the system is a two-aperture system. In this implementation, the system includes a first optic including a refractive lens 102 (e.g. first refractive lens) and a second optic including both a refractive lens 102 (e.g. second refractive lens) and a metasurface 104. The system also includes an imaging device configured to capture a first image through the first optic and a second image through the second optic. The type of imaging device is dependent on the type of radiation. Optionally, the imaging device is an infrared (IR) detector when radiation is in the IR band. An IR device is a device that detects IR radiation and converts it into an electrical signal. IR detectors include, but are not limited to, thermal detectors, photoconductive detectors, photovoltaic detectors, and pyroelectric detectors. Optionally, the imaging device is a photodetector when radiation is in the visible spectrum. A photodetector is a device that detects light and converts it into an electrical signal. Photodetectors include, but are not limited to, photodiodes, phototransistors, avalanche photodiodes, and photomultiplier tubes. It should be understood that IR detectors and photodetectors are provided only as an example imaging device. This disclosure contemplates using other devices capable of capturing images of the object.

The system can be used to image an object 110. In FIG. 1, the object 110 is the Vanderbilt logo. For example, non-limiting objects in the Examples below include towers, buildings, cars, and stadiums. This disclosure contemplates that the object 110 can be objects other than the Vanderbilt logo. The object 110 is imaged by creating a visual representation of the object 110. For example, imaging refers to capturing the optical information of the object 110 and producing a visual representation of it, e.g. on an imaging device. Imaging involves using optical devices such as the first and second optics to focus and capture incoherent radiation reflected or emitted by the object 110, resulting in an image that can be observed, analyzed, or stored for various purposes. Optionally, the incoherent radiation is in the LWIR band. LWIR refers to a specific range of wavelengths within the IR spectrum. IR radiation is electromagnetic radiation with longer wavelengths than those of visible light, but shorter than those of radio waves. And LWIR is characterized by longer wavelengths compared to other regions of the IR spectrum, e.g. spanning from approximately 7.5 to 13.5 micrometers (μm). LWIR radiation is associated with thermal imaging applications because objects at room temperature emit radiation primarily in this range. In a two-aperture system, the object 110 is imaged through a first aperture and the first optic, and the object 110 is separately imaged through a second aperture and the second optic. The first and second apertures are separate and distinct in this implementation. The first image captures a representation of the positive components of a derivative kernel, and the second image captures a representation of the negative components of a derivative kernel.

As described herein, the first optic is configured to form positive components of a derivative kernel (see “Positive Component” in FIG. 1), and the second optic is configured to form negative components of the derivative kernel (see “Negative Component” in FIG. 1). For example, the derivative kernel 120 can be a Laplacian kernel. Optionally, the Laplacian (∇²) kernel can be implemented as a Laplacian of Gaussian (LoG) function, which can be split into two components: a positive valued component approximated by the point spread function (PSF) of the refractive lens 102 and a negative valued component approximated by the PSF of the combination of the metasurface 104 and refractive lens 102. In the implementations described herein, the systems and methods are used for optical edge detection. Laplacian kernels can be effective for edge detection because they are capable of highlighting regions where intensity changes abruptly, such at an edge. It should be understood that the derivative kernel 120 can implement operators other than Laplacian depending on the features that are desired to be detected.

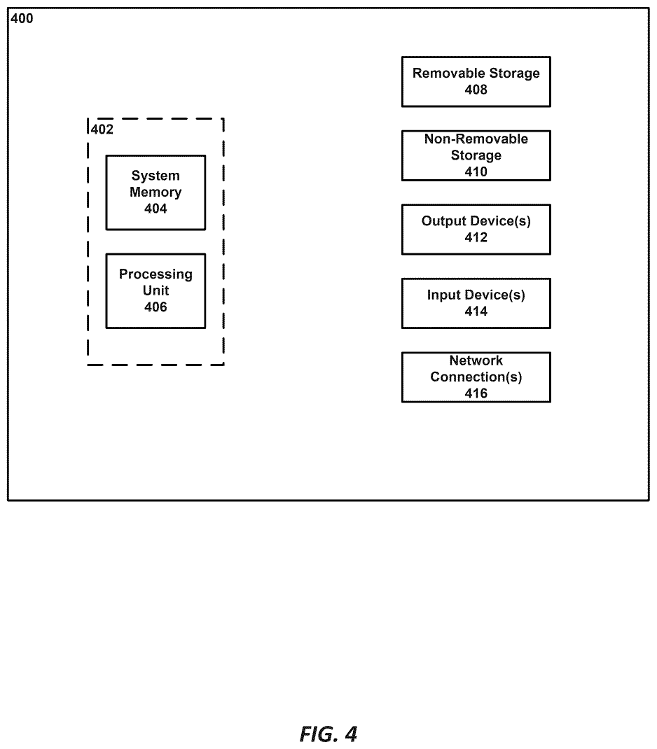

The system also includes at least one processor and at least one memory. The at least one processor and at least one memory can optionally have the basic configuration illustrated in FIG. 4 by box 402. Optionally, the at least one processor and at least one memory are part of a computing device such as computing device 400 illustrated in FIG. 4. The at least one processor is operably coupled to the imaging device. The at least one processor and the imaging device can be coupled through one or more communication links. This disclosure contemplates the communication links are any suitable communication link. For example, a communication link may be implemented by any medium that facilitates data exchange including, but not limited to, wired, wireless and optical links. Thus, the imaging device detects radiation and converts it into an electrical signal, which is transmitted to the at least one processor via the one or more communication links.

As described herein, the at least one processor can be configured to receive, from the imaging device, the first image and the second image. Additionally, the at least one processor can be configured to subtract the first image and the second image to obtain a feature-encoded image 130. As used herein, a feature-encoded image refers to an image where specific features have been encoded or represented in a structured way within image data. It should be understood that features are distinctive patterns or structures within an image that are relevant for a particular task, such as object detection, recognition, or segmentation. Such features can include, but are not limited to, edges, corners, texture patterns, shapes, or other visual cues. Accordingly, when an image is feature-encoded, it means that image data has been processed or transformed in such a way that these features are explicitly represented in the feature-encoded image. In the implementations described herein, the feature-encoded image 130 is an edge-encoded image. In other words, the systems and methods described herein have been applied for optical edge detection. It should be understood that edge detection is only provided as an example of feature detection. This disclosure contemplates that feature detection may include corner detection, blob detection, or other local feature detection. As described above, the derivative kernel can be selected for the appropriate task.

In other implementations, the system is a single-aperture system. In this implementation, the system includes an optic including both a refractive lens 102 and a metasurface 104. The metasurface 104 in these implementations is configured for polarization multiplexing, which exploits different polarization states of the radiation. The system also includes an imaging device configured to capture a plurality of images through the optic. The plurality of images are obtained simultaneously. As described above, the type of imaging device is dependent on the type of radiation. For example, the imaging device is optionally an IR detector when the radiation is in the IR band or a photodetector when the radiation is in the visible spectrum. Additionally, in the single-aperture system, the imaging device is a polarimetry-enabled device. Polarimetry involves determining the polarization state of radiation, which can be described by parameters such as the orientation, ellipticity, and intensity of polarization. A polarimetry-enabled device is a device that is sensitive to the polarization state of radiation. Radiation such as IR radiation or visible light is an electromagnetic wave, and its electric field oscillates in a specific plane as it propagates. Polarimetry-enabled devices are therefore designed to detect changes in the orientation of this electric field. A device can be made sensitive to the polarization state through various methods, including the design of the detector structure and the integration of polarization-sensitive elements. As non-limiting examples, polarization sensitivity can be achieved by selection of materials (e.g. anisotropic materials having different optical properties depending on direction of light polarization), incorporation of waveguides or gratings sensitive to the direction of polarization, and/or use of polarization filters.

The system can be used to image an object 110. In FIG. 1, the object 110 is the Vanderbilt logo. For example, non-limiting objects in the Examples below include towers, buildings, cars, and stadiums. This disclosure contemplates that the object 110 can be objects other than the Vanderbilt logo. The object 110 is imaged by creating a visual representation of the object 110. For example, imaging refers to capturing the optical information of the object 110 and producing a visual representation of it, e.g. on an imaging device. Imaging involves using optical devices such as the optic to focus and capture incoherent radiation reflected or emitted by the object 110, resulting in an image that can be observed, analyzed, or stored for various purposes. Optionally, the incoherent radiation is in the LWIR band. In a single-aperture system, the object 110 is imaged through a single aperture such that a plurality of images are captured simultaneously. The first image captures a representation of the positive components of a derivative kernel, and the second image captures a representation of the negative components of a derivative kernel.

As described herein, the optic is configured to form positive components of a derivative kernel (see “Positive Component” in FIG. 1) and negative components of the derivative kernel (see “Negative Component” in FIG. 1). For example, the derivative kernel 120 can be a Laplacian kernel. Optionally, the Laplacian (∇²) kernel can be implemented as a Laplacian of Gaussian (LoG) function. In the implementations described herein, the systems and methods are used for optical edge detection. Laplacian kernels can be effective for edge detection because they are capable of highlighting regions where intensity changes abruptly, such at an edge. It should be understood that the derivative kernel 120 can implement operators other than Laplacian kernel depending on the desired feature extraction.

The system also includes at least one processor and at least one memory. As described herein, the at least one processor can be configured to receive, from the imaging device, the plurality of images. Additionally, the at least one processor can be configured to subtract a first image and a second image of the plurality of images to obtain a feature-encoded image 130.

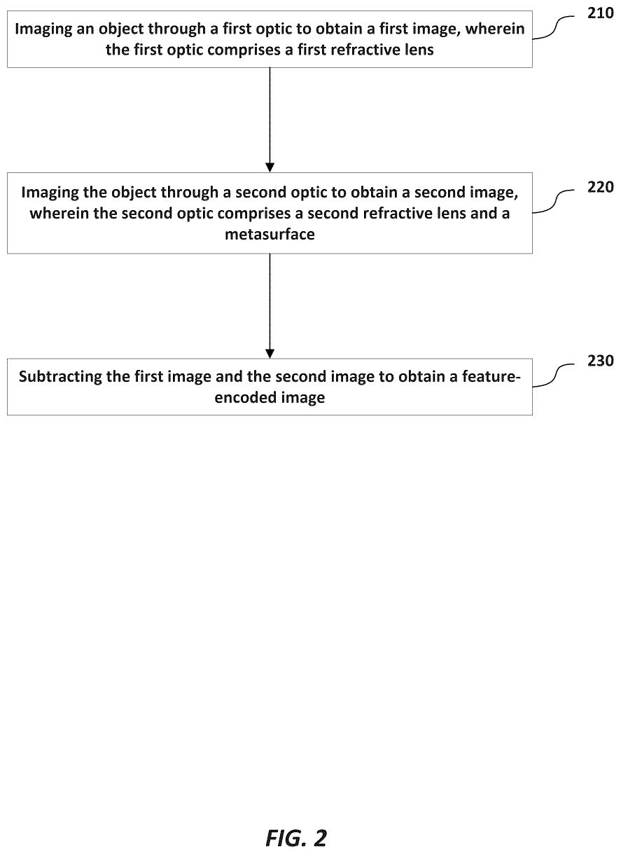

FIG. 2 is a flowchart of an example method for feature detection. This disclosure contemplates performing the method using the two-aperture system described with respect to FIG. 1.

At step 210, an object (e.g. object 110 in FIG. 1) is imaged through a first optic to obtain a first image, wherein the first optic comprises a first refractive lens (e.g. refractive lens 102 in FIG. 1). At step 220, the object is imaged through a second optic to obtain a second image, wherein the second optic comprises both a second refractive lens (e.g. refractive lens 102 in FIG. 1) and a metasurface (e.g. metasurface 104 in FIG. 1). An object is imaged by creating a visual representation of the object. For example, imaging refers to capturing the optical information of the object and producing a visual representation of it. Imaging involves using optical devices to focus and capture incoherent radiation reflected or emitted by the object, resulting in an image that can be analyzed for various purposes. At step 230, the first image and the second image are subtracted to obtain a feature-encoded image (e.g. feature-encoded image 130 in FIG. 1).

As described above, the first optic is configured to form positive components of a derivative kernel, and the second optic is configured to form negative components of the derivative kernel. Thus, the first image captures a representation of the positive components of the derivative kernel, and the second image captures a representation of the negative components of the derivative kernel. Optionally, the derivative kernel is a Laplacian kernel.

In some implementations, the metasurface includes a plurality of sub-wavelength structures. Additionally, the method optionally further includes optimizing the plurality of sub-wavelength structures using an inverse design process. An example optimization process is described in the Examples below.

In some implementations, the method further includes inputting the feature-encoded image into an artificial neural network (ANN). As described herein, optical convolution operations are offloaded to the first and second optics. It should be understood that such feature-encoded image can be further processed by a back-end digital ANN. This can include, but is not limited to, object detection, object recognition, object classification, and segmentation. In other words, further computer vision tasks can be performed by the back-end digital ANN upon receipt of the feature-encoded image. Optionally, the ANN is a deep neural network.

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, output layer, and optionally one or more hidden layers. An ANN having hidden layers can be referred to as deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. ANNs are known in the art and are therefore not described in further detail herein.

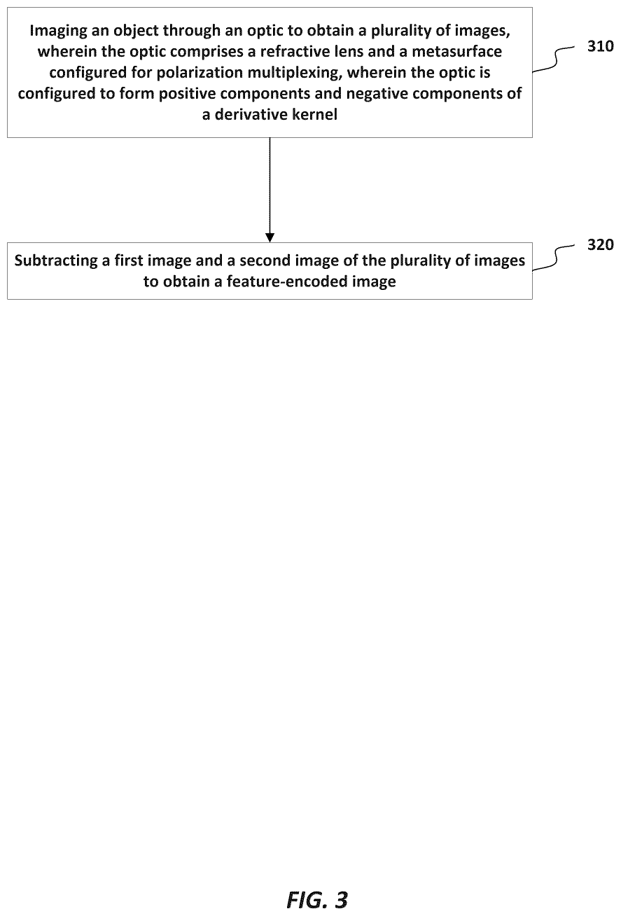

FIG. 3 is a flowchart of an example method for feature detection. This disclosure contemplates performing the method using the single-aperture system described with respect to FIG. 1.

At step 310, an object (e.g. object 110 in FIG. 1) is imaged through an optic to obtain a plurality of images, wherein the optic comprises both a refractive lens (e.g. refractive lens 102 in FIG. 1) and a metasurface (e.g. metasurface 104 in FIG. 1). The plurality of images are obtained simultaneously. In the single-aperture system, the metasurface is configured for polarization multiplexing as described herein. An object is imaged by creating a visual representation of the object. For example, imaging refers to capturing the optical information of the object and producing a visual representation of it. Imaging involves using optical devices to focus and capture incoherent radiation reflected or emitted by the object, resulting in an image that can be analyzed for various purposes. At step 320, a first image and a second image of the plurality of images are subtracted to obtain a feature-encoded image (e.g. feature-encoded image 130 in FIG. 1).

As described above, the optic is configured to form positive components and negative components of a derivative kernel. Thus, the first image captures a representation of the positive components of the derivative kernel, and the second image captures a representation of the negative components of the derivative kernel. Optionally, the derivative kernel is a Laplacian kernel.

In some implementations, the metasurface includes a plurality of sub-wavelength structures. Additionally, the method optionally further includes optimizing the plurality of sub-wavelength structures using an inverse design process. An example optimization process is described in the Examples below.

In some implementations, the method further includes inputting the feature-encoded image into an artificial neural network (ANN). As described herein, optical convolution operations are offloaded to the optic. It should be understood that such feature-encoded image can be further processed by a back-end digital ANN. This can include, but is not limited to, object detection, object recognition, object classification, and segmentation. In other words, further computer vision tasks can be performed by the back-end digital ANN upon receipt of the feature-encoded image. Optionally, the ANN is a deep neural network.

It should be appreciated that the logical operations described herein with respect to the various figures may be implemented (1) as a sequence of computer implemented acts or program modules (i.e., software) running on a computing device (e.g., the computing device described in FIG. 4), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 4, an example computing device 400 upon which the methods described herein may be implemented is illustrated. It should be understood that the example computing device 400 is only one example of a suitable computing environment upon which the methods described herein may be implemented. Optionally, the computing device 400 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 400 typically includes at least one processing unit 406 and system memory 404. Depending on the exact configuration and type of computing device, system memory 404 may be volatile (such as random access memory (RAM)), non-volatile (such as read-only memory (ROM), flash memory, etc.), or some combination of the two. This most basic configuration is illustrated in FIG. 4 by box 402. The processing unit 406 may be a standard programmable processor that performs arithmetic and logic operations necessary for operation of the computing device 400. The computing device 400 may also include a bus or other communication mechanism for communicating information among various components of the computing device 400.

Computing device 400 may have additional features/functionality. For example, computing device 400 may include additional storage such as removable storage 408 and non-removable storage 410 including, but not limited to, magnetic or optical disks or tapes. Computing device 400 may also contain network connection(s) 416 that allow the device to communicate with other devices. Computing device 400 may also have input device(s) 414 such as a keyboard, mouse, touch screen, etc. Output device(s) 412 such as a display, speakers, printer, etc. may also be included. The additional devices may be connected to the bus in order to facilitate communication of data among the components of the computing device 400. All these devices are well known in the art and need not be discussed at length here.

The processing unit 406 may be configured to execute program code encoded in tangible, computer-readable media. Tangible, computer-readable media refers to any media that is capable of providing data that causes the computing device 400 (i.e., a machine) to operate in a particular fashion. Various computer-readable media may be utilized to provide instructions to the processing unit 406 for execution. Example tangible, computer-readable media may include, but is not limited to, volatile media, non-volatile media, removable media and non-removable media implemented in any method or technology for storage of information such as computer readable instructions, data structures, program modules or other data. System memory 404, removable storage 408, and non-removable storage 410 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 406 may execute program code stored in the system memory 404. For example, the bus may carry data to the system memory 404, from which the processing unit 406 receives and executes instructions. The data received by the system memory 404 may optionally be stored on the removable storage 408 or the non-removable storage 410 before or after execution by the processing unit 406.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### Examples

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° °C or is at ambient temperature, and pressure is at or near atmospheric.

Optical edge detection is readily achievable under coherent illumination because interference in coherent systems allows for direct, fully optical edge detection. A conventional approach has been to use a 4f system to apply a frequency space filter to incoming light (6-9), although recent approaches employing metasurfaces (10-16) have achieved similar filtering in a more compact form; photonic crystal slabs (17, 18), multilayer films (19, 20), and dielectric reflectors (21) have also been proposed. Most real-world imaging applications are passive, involving incoherent illumination or thermal emission, for which it is not possible to perform fully optical edge detection due to inherent constraints on the incoherent point spread function (PSF). The incoherent PSF is an intensity distribution, thus is constrained to real, positive values, whereas all PSFs capable of edge detection require both positive and negative values (22). However, a bipolar PSF can be synthesized with a hybrid optoelectronic system, which collects two images using two different PSFs, then performs pixel-by-pixel digital subtraction (6). This can be achieved with two separate apertures, or a single aperture with wavelength (23, 24) or polarization (25) multiplexing.

While previous approaches have successfully demonstrated incoherent edge detection in simulated or laboratory conditions (23-25), they have not fully addressed the challenges associated with edge detection in real-world scenes involving ambient illumination or thermal emission. Incoherent light sources are inherently broadband, thus practical optic design must consider chromatic aberration. In addition, the broadband PSFs of the optical system will determine not only the quality and resolution of the edge images but also the signal-to-noise ratio (SNR), because of noise accumulation during digital subtraction (26, 27). A bandwidth filter or reduced aperture could be used to simplify the optic design, but doing either would block valuable signal, limiting the sensitivity of the system and hindering its use in low light settings. This is particularly true in the long-wave infrared (LWIR) regime which has become ubiquitous in autonomous systems due to the ability to see in low-visibility (28, 29) conditions and to identify objects based on their thermal signature (30). Implementation of optical edge detection for LWIR thermal emission is especially difficult because thermal emission is not only incoherent and broadband but is also limited in signal and contrast (29). Therefore, to achieve optimal performance, the optics should be designed to operate across the camera's entire bandwidth and aperture, while simultaneously considering the quality, resolution, and signal in the resulting edge images.

Metasurfaces offer a compact platform for efficient control of phase, amplitude, and polarization of light, which makes them a valuable tool for shaping PSFs for optical edge detection. The aperture size, numerical aperture, and operational bandwidth of metalenses are related, however, ultimately leading to narrowing of the operational bandwidth as the lens size is increased (31, 32). To address this issue, various strategies such as multilayer (33), cascaded (34), aperiodic (35), or extended depth-of-focus (36) metasurfaces have been explored to improve chromatic performance. Nevertheless, these approaches still face such challenges as limited focusing efficiency or small device size. An alternative solution involves combining a conventional refractive lens with a metasurface corrector (37). In this approach, the refractive lens provides naturally broadband focusing while the metasurface imparts a wavelength-dependent phase correction—with a substantially relaxed maximum dispersion requirement—leading to large-scale, broadband performance.

Described herein is a long-wave infrared (LWIR) electro-optical edge detection system that works in real-world conditions by combining a refractive optic with a large-aperture, inversely designed metasurface to create positive and negative components of a bipolar Laplacian kernel. The system is demonstrated first in a two-aperture approach, followed by extension into a single-aperture architecture using polarization multiplexing. In both cases, combination with a refractive optic allows us to overcome the typical bandwidth limitations associated with large aperture metalenses. In addition, inverse design is used to optimize performance for broadband LWIR emission while also preserving the signal-to-noise ratio (SNR) in the synthesized edge images. The system is employed for LWIR electro-optical edge detection of thermal emission from real world scenes, which demonstrates the viability of this approach for implementation as an accelerated front-end for practical computer vision systems.

### Results

### Principals of Design

Designing an optic for edge detection can be approached by shaping the effective PSF into a derivative kernel, such as the Laplacian of Gaussian (LoG) kernel (38), as shown in FIG. 1. Any kernel used for edge detection must have both positive and negative values. Thus, the Laplacian (∇²) kernel is implemented as a Laplacian of Gaussian (LoG) function, which can be split into two components: a positive valued component approximated by the PSF of a refractive lens and a negative valued component approximated by the PSF of a spiral phase metasurface and a refractive lens. In contrast with coherent edge detection systems (18) that benefit from linearity with respect to the electric fields of light, incoherent imaging systems are linear with respect to light intensity, which constrains the incoherent PSF to only positive values. Hence, it is not possible to optically detect edges with a single PSF under incoherent illumination. Bipolar edge detection kernels can be synthesized by an optoelectronic system, however, by separating the desired kernel into its constituent positive and negative components. FIG. 1 shows how the LoG kernel can be decomposed into positive and negative component PSFs, which can be formed by an incoherent imaging system; a refractive lens 102 can form the positive component, and the combination of a specifically designed phase plate (e.g. metasurface 104) with a refractive lens 102 can form an annular ring as the negative component. For example, a spiral phase plate produces an annular ring shaped PSF, due to a phase singularity at the center of the focal spot (39). Digital subtraction of images collected with the two optics under the same acquisition conditions yields an edge-encoded image corresponding to an approximate LoG kernel.

### Metasurface Design

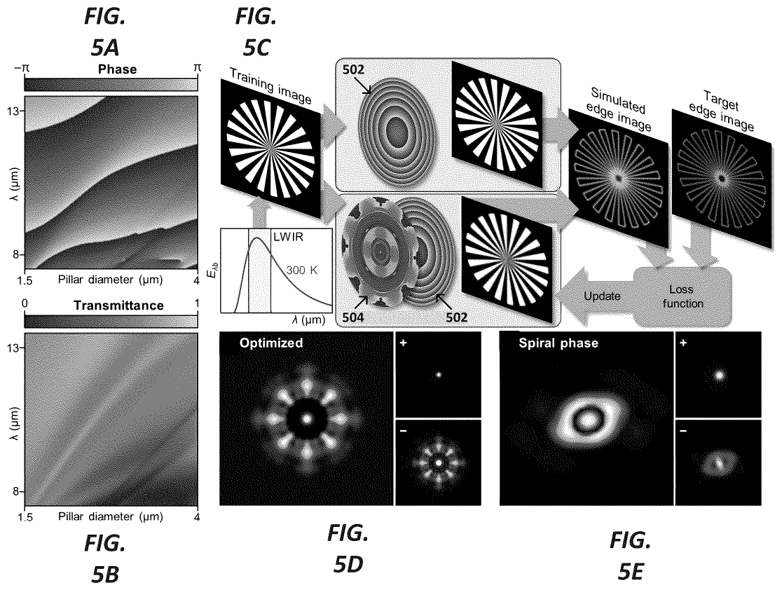

While the spiral phase plate illustrated in FIG. 1 produces a Laplacian kernel, it is not optimized for operational bandwidth, edge resolution, or SNR. In order to realize an imaging system where these factors are considered, an inverse design process was utilized for optimization of the negative component of the PSF. The positive component was taken as the PSF from the 24 mm F/1 refractive lens of an off-the-shelf FLIR Boson 640 and the negative component is a superposition of the same refractive lens with an optimized metasurface. To accomplish this, a broadband library of cylindrical silicon meta-atoms, sitting on a double side polished silicon substrate, was generated using rigorous coupled-wave analysis (RCWA). The phase and transmittance of the library is plotted in FIGS. 5A and 5B. Cylindrical geometry was chosen to facilitate fabrication using scalable mask-based photolithography. Pillar height and pitch were chosen to be 6.5 μm and 5 μm, respectively, based on parameter sweeps. Although this library has smooth phase coverage across bandwidth, it does not allow for prescribed control of dispersion, thus it is not possible to completely avoid chromatic aberration using this library, especially for the broad 7.5-13.5 μm LWIR imaging band and 24 mm aperture studied here, making forward design approaches difficult.

In order to optimize the broadband PSF within the constraints of the meta-atom library, the inverse design algorithm used gradient descent to set the dimensions of the pillars in each unit cell for minimal error in synthesized edge images, as shown in the schematic in FIG. 5C. In FIG. 5C, a refractive lens 502 and metasurface 504 are labeled. A metasurface was initialized with randomly radially varying meta-atom geometry across its area; initializing with radially varying parameters instead of fully random produced results with more symmetric point spread functions, without constraining the metasurface to be fully axisymmetric. The incoherent PSF of the optic system in both positive and negative configurations was calculated using the angular spectrum method at evenly spaced wavelengths across the design bandwidth. The positive and negative PSFs were scaled to unity total intensity before evaluating their difference to calculate the effective bipolar PSF. This effective PSF was convolved with a Siemens star used for training. This simulated image was compared with a target edge image defined by filtering the training image with an exact LoG kernel; by comparing the simulated and target images, as opposed to directly comparing the simulated and target PSF, the solver finds designs that produce Laplacian edge images, without rigidly constraining the designed system PSF to the LoG function. Gradient descent was performed with respect to the loss function defined in Eq. 1,

$$L = \sum {( {I}_{i} - {I}_{target} )}^{2} + α \frac{2 \sum \vert O \vert}{\sum \vert {I}_{i} \vert} + β \sum {\vert ∇ D \vert}^{2} . \qquad ( 1 )$$

The loss function includes three terms: a sum of squared errors between the simulated and target edge images, an inverse of the relative signal strength in the edge image, and a penalty on the spatial gradient of the meta-atom width to smooth the metasurface phase profile, which improves convergence speed and broadband performance. Hyperparameters α and β set the relative weight of the terms. Including a term that rewards high signal strength helps avoid unnecessary overlap between component PSFs that leads to signal losses during digital subtraction. When the two PSFs overlap, the resulting signal in the difference image will cancel out, but the noise, which is uncorrelated between images, will accumulate (26). For comparison, a heuristic, forward design process was used to create a spiral phase metasurface at a central operation wavelength of 10 μm.

The advantages of the inverse design process can be observed by comparing the simulated, broadband effective PSFs for the inversely designed metasurface and the spiral phase metasurface shown in FIGS. 5D and 5E respectively. The broadband PSF for the spiral phase metasurface is no longer symmetric due to dispersion, whereas the PSF for the optimized metasurface has sufficient symmetry for isotropic edge detection. The optimized metasurface is also better at reducing overlap between component PSFs; the signal loss due to component PSF overlap is 51% lower using the optimized design compared to the spiral phase. Additionally, the optimized bipolar PSF has a region with near zero intensity separating the positive and negative regions. This PSF shape increases the system response to high spatial frequencies, while preserving the desired Laplacian filtering effect at low frequencies, resulting in more signal at sharp edges compared to an exact LoG. There is a trade-off between the resolution and the SNR of the designed devices. The SNR is improved by increasing the separation between the positive and negative PSFs, which means that better SNR solutions have larger effective focal spots and therefore lower resolution. The desired balance between SNR and resolution for a particular application can be achieved by adjusting the weight a of the SNR loss term as well as the variance of the gaussian used to generate the target edge image.

### Experimental Characterization

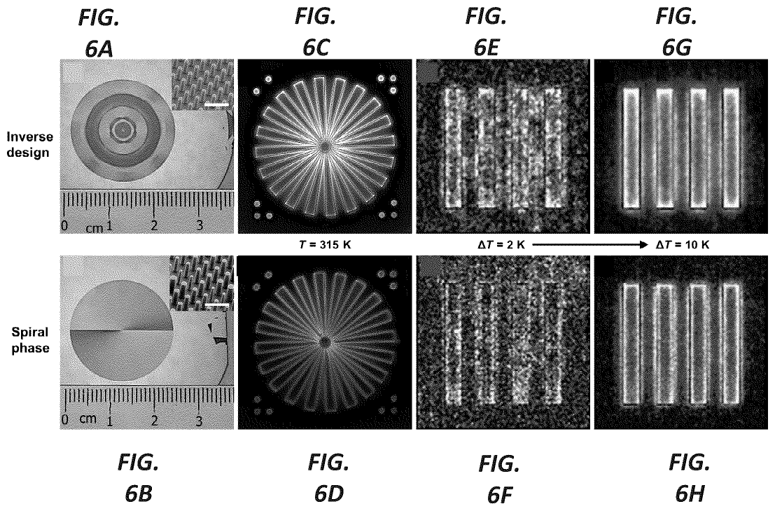

Both the inversely design and spiral phase metasurfaces were fabricated (FIGS. 6A and 6B) and characterized with a combination of laboratory and real-world imaging. The broadband transmission efficiency of each metasurface was measured and transmission losses were compensated for during edge image synthesis. In practice, this correction factor could be incorporated into the camera's non-uniformity correction, and therefore would not increase the number of digital operations needed to form the edge image. The measured transmission efficiency of the inversely designed metasurface was 38%, which includes losses from the metasurface reflection, backside reflection, and substrate absorption, which were estimated to be 43.3%, 30.3%, and 2.6%, respectively. The transmission efficiency of the spiral phase metasurface was 44%. Maximizing the transmittance of the metasurfaces was not the primary goal of this study and it could be increased by using a lower index substrate, adding an antireflective coating on the back side, or embedding the meta-atoms in a low-index coating to decrease the impact of the impedance mismatch between the substrate and air. The overall performance of spatial filters, such as this, is better quantified by the maximum spatial frequency for which they still retain the desired modulation transfer function (MTF), and the magnitude of their MTF at that spatial frequency. The calculated effective MTF of the inversely designed two aperture system exhibits the desired parabolic behavior (24) up to a maximum at 0.272 cy/mrad, which could be considered the spatial bandwidth for differentiation. The magnitude of the MTF of our system at that frequency is 0.854 and can be compared to the exact LoG which has a peak value of 1.0. The high MTF of the inversely designed metasurface is achieved because of the minimal overlap between the broadband component PSFs.

The experimental signal strength and resolution of the edge detection imaging system were characterized by imaging a blackbody Siemens star with a temperature of 315 K. FIGS. 6A and 6B show resulting edge images formed using the spiral phase and optimized metasurfaces respectively; this pair of images use the same color scale to demonstrate the increased signal strength in the optimized metasurface. The peak edge signal using the inversely designed metasurface was on average 67% higher across all edge orientations and spatial frequencies, meaning the optimized metasurface delivers a higher SNR and thus can be used to detect edges in lower contrast scenes. The edge detection for the optimized metasurface is also invariant to edge orientation, unlike the spiral phase, which detects some edge orientations more strongly due to the asymmetry of the spiral phase PSF under broadband illumination.

The limit on the minimum contrast needed for edge detection was explored by imaging blackbody bar targets with low temperature differentials, as shown in FIG. 6E-6H. The inverse design metasurface begins to detect edges for a temperature differential as low as 1 K. The strength and accuracy of the detected edges quickly improves with temperature. At a 2 K differential, some edges are visible for both the spiral phase and optimized metasurface images. However, the edges in the optimized metasurface image are brighter and more reliably detected on each bar compared to the spiral phase metasurface image, which is missing edges in large regions on the image. At a temperature difference of 10 K, both metasurfaces can reliably detect edges. However, the spiral phase image still exhibits noticeable noise. On the other hand, the optimized metasurface provides a stronger edge signal, which effectively overpowers the noise.

To achieve low contrast edge detection, the inverse design prioritized SNR over resolution, which imposed a limit on the maximum spatial frequency for identifying edges distinctly. The maximum spatial frequency for distinct edge detection was determined from the spoke target images in FIGS. 6A-6H and defined as the frequency where the peak edge signal has at least 50% contrast with the trough between edges. The maximum spatial frequency with at least 50% edge contrast is 0.076 cy/mrad for the spiral phase metasurface and 0.053 cy/mrad for the optimized metasurface. This is a conservative criterion, as evidenced by the 0.1 cy/mrad bar targets in FIGS. 6G and 6H, which despite being above the cutoff, still have clearly visible edges, albeit with some noticeable background signal.

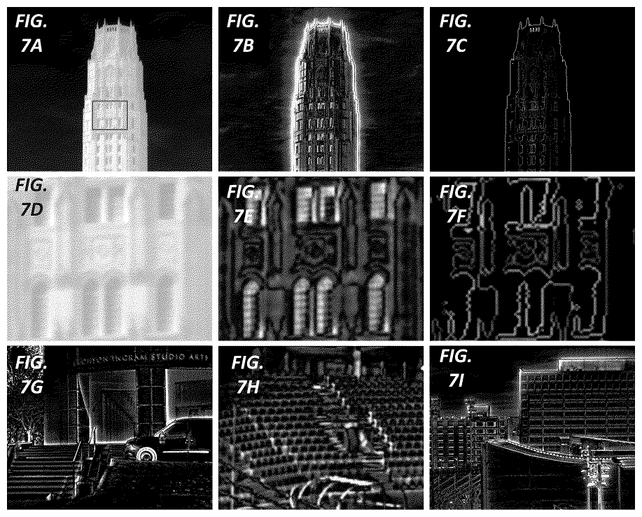

The edge detector acts as a high pass filter; features much smaller than the above limit are entirely above the cutoff frequency. Instead of being outlined, the entire feature is highlighted in the edge image, with enhanced contrast because the uniform background signal is removed. The smallest feature that can be detected in this manner is only limited by the resolution of the original imaging system, before modification of the metasurface. This is demonstrated in the real-word imagery in FIGS. 7A-7F, which shows a conventional LWIR image and its corresponding edge image of a distant tower with many small windows and architectural features. The tower is very prominently outlined, while the small windows and features are highlighted. FIG. 7E is a blown-up view of the edge image, in which you can see the individual grilles on the windows and the patterns in the stonework, despite the small size and low contrast of these features in the unaltered LWIR image. If an application requires specific edge locations for these small features, the zero crossings in the image can be found as shown in FIGS. 7C and 7F, as is typical for Laplacian-based edge detection (38). In such applications, the optical system presented here replaces the digital LoG convolution, decreasing computation time. Edge images for a variety of other real-world scenes are depicted in FIG. 7G-7I, which demonstrate the edge detector performance for a wide span of feature sizes and contrasts; additional full-size images are available in the supplementary material.

### Single Aperture Design Using Polarization Sensitive Metasurface

The ability for metasurfaces to multiplex according to polarization potentiates the implementation of single-aperture optoelectronic feature detection, in contrast with the two-aperture approach described in the previous sections which would require careful alignment of two temporally synchronous cameras to capture the positive and negative component images while accounting for parallax errors. The single aperture approach uses a refractive lens for broadband focusing as well as a si(40, 41) refringent metasurface (40, 41) that independently shapes the PSF for light with two orthogonal polarization states into the positive and negative component PSFs. Using a polarimetry enabled camera, separate images would be simultaneously collected for the two polarizations yielding the synthesized edge image through digital subtraction.

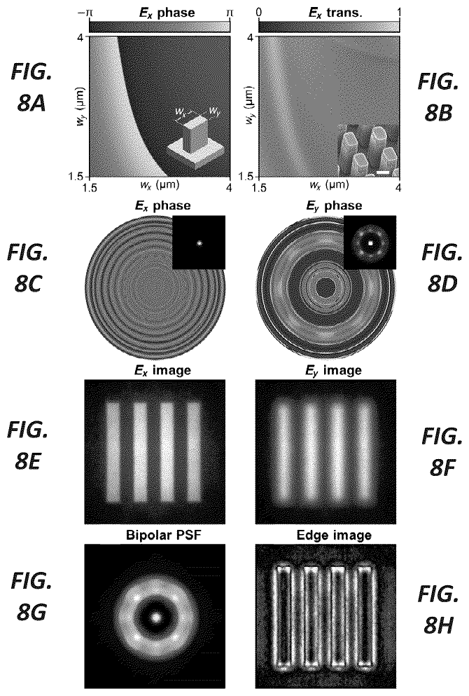

In order to realize single aperture edge imaging, the inverse design of a polarization sensitive metasurface was performed using a similar method as elaborated earlier. The library of rectangular birefringent meta-atoms shown in FIGS. 8A and 8B was utilized. The design of the polarization sensitive metasurface involved optimizing the x- and y-axis widths of each meta-atom to independently control the phase profiles for x- and y-polarized light. Because this model had twice as many meta-atom parameters to optimize and required simultaneous optimization of the PSFs for both polarization states, its memory requirement was much larger. As a consequence, it was not possible to simulate the PSF at fine wavelength samples across the entire bandwidth in each iteration. To make this work with the available computing resources, in each iteration, the PSF was calculated for a small, randomly selected batch of wavelengths, instead of evenly sampling across the bandwidth. To improve the robustness of the solution, the location of the point source used to calculate the PSF was also dithered. Lastly, the adaptive loss weighting method by Heydari et al. (42) was implemented to retain fast convergence despite the additional randomness due to mini-batching.

The optimized phase profiles in each polarization state are shown in FIGS. 8C and 8D. The PSF for x-polarized light is tightly focused, as apparent the corresponding bar target image in FIG. 8E, while the PSF for y-polarized light is shaped into an annular ring, resulting in the slightly blurred image in FIG. 8F. Digital subtraction of the images for the two polarization states results in the edge image in FIG. 8H, which is consistent with the simulated effective bipolar PSF in FIG. 8G. The increased noise is primarily due to ambient emissions reflected into the camera from a polarizer, which would not be necessary when implementing this approach with a polarimetric camera. The calculated effective MTF of the one aperture design, normalized for reflection losses, has a maximum of 1.0 at a frequency of 0.258 cy/mrad. This higher magnitude is attributed to the extra design degrees of freedom afforded by the birefringent meta-atom library, as well as the improvements to the inverse design algorithm added for the single aperture design (wavelength mini-batching, point source dithering, and adaptive loss weighting). This demonstration illustrates that the presented approach can be applied to design an effective single aperture optoelectronic edge encoder using polarization multiplexing. When used with a polarimetric camera, this approach facilitates live edge detection in a lightweight system with no need for multiple aperture alignment.

### DISCUSSION

In conclusion, we have presented an electro-optical system for broadband, high-signal to noise ratio, incoherent edge detection with operation across the 7.5-13.5 μm LWIR imaging band. This performance was enabled by a hybrid optical system comprising a refractive optic and a metasurface combined with multi-objective inverse design. These advances enable imaging of real-world scenes using off-the-shelf hardware and the approach was extended to a single aperture approach by using a birefringent metasurface in combination with polarization discrimination at the imaging sensor. While the presented systems are designed to apply a Laplacian filter, the approach can be applied to arbitrary differentiation and convolution operations.

This demonstration of high SNR, broadband optical feature detection could be adapted to achieve practical optical front-end preprocessing for computer vision systems. Offloading low-level feature detection onto an imaging system has the potential to improve the performance of common computer vision systems by reducing both power consumption and latency. Typical digital convolutional layers consist of several parallel convolutional channels, which could be achieved optically using a division of aperture mini-lens array (43), combined with a birefringent metasurface array used to shape the PSF of each mini-lens. Whereas the computation time for digital convolution scales with the size of the convolution kernel, optical convolution speed is invariant to kernel size, and could enable substantial acceleration when used with shallow networks enabled by large convolution kernels (44). This could be particularly impactful for autonomous and remote sensing systems which face size, weight, and power consumption constraints but must also perform on-board processing due to latency or communication bandwidth requirements.

### Materials and Methods

### Simulation

The meta-atom libraries were generated using the RCWA software Reticolo Software for Grating Analysis (45). The inverse design algorithm leveraged the Pytorch machine learning package, which enabled GPU computing and automatic gradient calculation. Forward propagation steps were calculated using the angular spectrum method, using a memory efficient 2D fast Fourier transform algorithm to enable simulation of larger devices. Inverse design calculations were performed on an Nvidia Quadro M6000 24 Gb GPU. The image used for training was a 60-spoke Siemens star target with a resolution of 600 by 600 pixels (7.2 by 7.2 mm on the focal plane array). The target edge images were formed by convolving the Siemens star image with a LoG kernel. The variance of the LoG is a tunable hyperparameter that influences the resolution of the design; the presented designs were generated using a variance of 0.82 mrad.

### Metasurface Fabrication

The metasurfaces were comprised of etched pillars on undoped, double-side polished Si substrates with 280 μm thickness. Negative photolithography masks containing the inversely designed geometric features were ordered from Digidat (Pasadena, CA), and subsequently used to pattern a layer of s1805 positive photoresist on the Si substrate. The pattern was transferred to a 125 nm Al₂O₃ hard mask by electron beam deposition followed by liftoff using Microposit Remover 1165. The hard mask pattern was transferred to the pillars by selective reactive ion etching of the exposed Si to a depth corresponding to the designed height of the pillars (6.5 μm for inversely designed metasurfaces, 7.0 μm for the spiral phase metasurface). The thin remaining layer of Al₂O₃ on the tops of the pillars was not removed, which may have introduced a small absorptive loss (<10%) at the higher wavelengths but otherwise did not substantially alter the metasurface phase because of the low thickness and refractive index of Al₂O₃.

### Experimental Setup

Laboratory and field imagery were collected on a FLIR Boson 640 camera with a 24 mm, F/1 lens with 18° HFOV. Most of the built-in preprocessing for the Boson was disabled using the FLIR Boson app v3.0, with the exception of the non-uniformity correction and defect pixel replacement. The Boson was aligned with a cage system to facilitate quick and consistent insertion and removal of the metasurface between complementary frames. The position of the metasurface on the cage was controlled such that the metasurface would be within 1 mm of the Boson lens mount during imaging, with the metasurface facing towards the camera. Laboratory imaging of bar targets was performed on a 60-inch focal length optical collimator bench (Santa Barbara Infrared, Inc.; Santa Barbara, CA) with a black-body source projected through various target plates.

The transmission efficiency of each metasurface was measured by imaging the blackbody source at temperatures from 300 K and 370 K in increments of 10 K with and without the metasurface installed; the efficiency was calculated via regression as the ratio of the changes in signal with and without the metasurface installed. These transmission calculations included pixels in uniform regions within a 1.4° square field of view at the center of the image.

### REFERENCES

1. Y. Lecun, Y. Bengio, G. Hinton, Deep learning. Nature 521, 436-444 (2015).
2. K. Han, Y. Wang, H. Chen, X. Chen, J. Guo, Z. Liu, Y. Tang, A. Xiao, C. Xu, Y. Xu, Z. Yang, Y. Zhang, D. Tao, A Survey on Vision Transformer. IEEE Trans Pattern Anal Mach Intell 45, 87-110 (2023).
3. D. Ghimire, D. Kil, S. Kim, A Survey on Efficient Convolutional Neural Networks and Hardware Acceleration. Electronics (Basel) 11, 945 (2022).
4. M. K. Chen, X. Liu, Y. Sun, D. P. Tsai, Artificial Intelligence in Meta-optics. Chem Rev 122, 15356-15413 (2022).
5. G. Habib, S. Qureshi, Optimization and acceleration of convolutional neural networks: A survey. Journal of King Saud University—Computer and Information Sciences 34, 4244-4268 (2022).
6. W. T. Rhodes, Incoherent Spatial Filtering. Optical Engineering 19, 193323 (1980).
7. J. Zhou, H. Qian, J. Zhao, M. Tang, Q. Wu, M. Lei, H. Luo, S. Wen, S. Chen, Z. Liu, Two-dimensional optical spatial differentiation and high-contrast imaging. Natl Sci Rev 8, 2021 (2021).
8. X. Qiu, F. Li, W. Zhang, Z. Zhu, L. Chen, Spiral phase contrast imaging in nonlinear optics: seeing phase objects using invisible illumination. Optica 5, 208 (2018).
9. A. Jesacher, S. Bernet, M. Ritsch-Marte, S. R. Oemrawsingh, J. A. W van Houwelingen, E. R. Eliel, J. P. Woerdman, E. J. K Verstegen, J. G. Klooster-boer, Spiral phase contrast imaging in microscopy. Optics Express, 13, 689-694 (2005).
10. W. Fu, D. Zhao, Z. Li, S. Liu, C. Tian, K. Huang, Ultracompact meta-imagers for arbitrary all-optical convolution. Light Sci Appl 11, 62 (2022).
11. H. Kwon, D. Sounas, A. Cordaro, A. Polman, A. Alù, Nonlocal Metasurfaces for Optical Signal Processing. Phys Rev Lett 121, 173004 (2018).
12. S. Abdollahramezani, O. Hemmatyar, A. Adibi, Meta-optics for spatial optical analog computing. Nanophotonics 9, 4075-4095 (2020).
13. L. Wan, D. Pan, T. Feng, W. Liu, A. A. Potapov, A review of dielectric optical metasurfaces for spatial differentiation and edge detection. Frontiers of Optoelectronics 14, 187-200 (2021).
14. A. Komar, R. A. Aoni, L. Xu, M. Rahmani, A. E. Miroshnichenko, D. N. Neshev, Edge Detection with Mie-Resonant Dielectric Metasurfaces. ACS Photonics 8, 864-871 (2021).
15. J. Zhou, J. Zhao, Q. Wu, C. Chen, M. Lei, G. Chen, F. Tian, Z. Liu, Nonlinear Computational Edge Detection Metalens. Adv Funct Mater 32, 2204734 (2022).
16. Z. Wang, G. Hu, X. Wang, X. Ding, K. Zhang, H. Li, S. N. Burokur, Q. Wu, J. Liu, J. Tan, C.-W. Qiu, Single-layer spatial analog meta-processor for imaging processing. Nat Commun 13, 2188 (2022).
17. C. Guo, M. Xiao, M. Minkov, Y. U. Shi, S. Fan, Photonic crystal slab Laplace operator for image differentiation. Optica, Vol. 5, Issue 3, pp. 251-256 5, 251-256 (2018).
18. Y. Zhou, H. Zheng, I. I. Kravchenko, J. Valentine, Flat optics for image differentiation. Nat Photonics 14, 316-323 (2020).
19. W. Xue, O. D. Miller, High-NA optical edge detection via optimized multilayer films. Journal of Optics 23, 125004 (2021).
20. C. Jin, Y. Yang, Transmissive nonlocal multilayer thin film optical filter for image differentiation. Nanophotonics 10, 3519-3525 (2021).
21. T. Zhu, C. Guo, J. Huang, H. Wang, M. Orenstein, Z. Ruan, S. Fan, Topological optical differentiator. Nat Commun 12, 680 (2021).
22. R. Maini, H. Aggarwal, Study and Comparison of Various Image Edge Detection Techniques. International Journal of Image Processing 3, (2009)
23. H. Wang, C. Guo, Z. Zhao, S. Fan, Compact Incoherent Image Differentiation with Nanophotonic Structures. ACS Photonics 7, 338-343 (2020).
24. X. Zhang, B. Bai, H. Sun, G. Jin, J. Valentine, Incoherent Optoelectronic Differentiation Based on Optimized Multilayer Films. Laser Photon Rev 16, 2200038 (2022).
25. D. Hazineh, S. W. D. Lim, Q. Guo, F. Capasso, T. Zickler, “Polarization Multi-Image Synthesis with Birefringent Metasurfaces” in 2023 IEEE International Conference on Computational Photography (2023).
26. A. W. Lohmann, W. T. Rhodes, Two-pupil synthesis of optical transfer functions. Appl Opt 17, 1141-1151 (1978).
27. J. N. Mait, W. T. Rhodes, Pupil function design algorithm for bipolar incoherent spatial filtering. Appl Opt 28, 1474 (1989).
28. A. Mukhtar, L. Xia, T. B. Tang, Vehicle Detection Techniques for Collision Avoidance Systems: A Review. IEEE Transactions on Intelligent Transportation Systems 16, 2318-2338 (2015).
29. X. Dai, X. Yuan, X. Wei, TIRNet: Object detection in thermal infrared images for autonomous driving. Applied Intelligence 51, 1244-1261 (2021).
30. M. Teutsch, T. Mueller, M. Huber, J. Beyerer, Low resolution person detection with a moving thermal infrared camera by hot spot classification. IEEE Computer Society Conference on Computer Vision and Pattern Recognition Workshops, 209-216 (2014).
31. A. Arbabi, A. Faraon, Advances in optical metalenses. Nat Photonics 17, 16-25 (2023).
32. M. K. Chen, Y. Wu, L. Feng, Q. Fan, M. Lu, T. Xu, D. P. Tsai, Principles, Functions, and Applications of Optical Meta-Lens. Adv Opt Mater 9 (2021).
33. Y. Zhou, I. I. Kravchenko, H. Wang, J. R. Nolen, G. Gu, J. Valentine, Multilayer Noninteracting Dielectric Metasurfaces for Multiwavelength Metaoptics. Nano Lett 18, 7529-7537 (2018).
34. A. S. Backer, Computational inverse design for cascaded systems of metasurface optics. Opt Express 27, 30308 (2019).
35. H. Chung, O. D. Miller, High-NA achromatic metalenses by inverse design. Opt Express 28, 6945 (2020).
36. E. Bayati, R. Pestourie, S. Colburn, Z. Lin, S. G. Johnson, A. Majumdar, Inverse designed extended depth of focus meta-optics for broadband imaging in the visible. Nanophotonics 11, 2531-2540 (2022).
37. W. T. Chen, A. Y. Zhu, J. Sisler, Y. W. Huang, K. M. A. Yousef, E. Lee, C. W. Qiu, F. Capasso, Broadband Achromatic Metasurface-Refractive Optics. Nano Lett 18, 7801-7808 (2018).
38. D. Marr, E. Hildreth, Theory of edge detection. Proc R Soc Lond B Biol Sci 207, 187-217 (1980).
39. E. Hecht, Optics (Pearson, ed. 5, 2016).
40. A. Arbabi, Y. Horie, M. Bagheri, A. Faraon, Dielectric metasurfaces for complete control of phase and polarization with subwavelength spatial resolution and high transmission. Nat Nanotechnol 10, 937-943 (2015).
41. X. Wang, H. Wang, J. Wang, X. Liu, H. Hao, Y. S. Tan, Y. Zhang, H. Zhang, X. Ding, W. Zhao, Y. Wang, Z. Lu, J. Liu, J. K. W. Yang, J. Tan, H. Li, C.-W. Qiu, G. Hu, X. Ding, Single-shot isotropic differential interference contrast microscopy. Nat Commun 14, 2063 (2023).
42. A. A. Heydari, A. Mehmood, “SRVAE: super resolution using variational autoencoders” in Pattern Recognition and Tracking XXXI, M. S. Alam, Ed. (SPIE, 2020), p. 30.
43. J. L. Pezzaniti, D. B. Chenault, “A division of aperture MWIR imaging polarimeter” in Polarization Science and Remote Sensing II, J. A. Shaw, J. S. Tyo, Eds. (SPIE, 2005) vol. 5888, p. 58880V.
44. X. Ding, X. Zhang, J. Han, G. Ding, “Scaling Up Your Kernels to 31×31: Revisiting Large Kernel Design in CNNs” in 2022 IEEE/CVF Conference on Computer Vision and Pattern Recognition (CVPR) (IEEE, 2022), pp. 11953-11965.
45. J. P. Hugonin, P. Lalanne, RETICOLO software for grating analysis. (2021).
46. A. Trujillo-Pino, K. Krissian, M. Alemán-Flores, D. Santana-Cedrés, Accurate subpixel edge location based on partial area effect. Image Vis Comput 31, 72-90 (2013).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for optical edge detection comprising:
imaging an object through a first optic to obtain a first image, wherein the first optic comprises a first refractive lens;
imaging the object through a second optic to obtain a second image, wherein the second optic comprises a second refractive lens and a metasurface; and
subtracting the first image and the second image to obtain a feature-encoded image.

2. The method of claim 1, wherein the first optic is configured to form positive components of a derivative kernel, and wherein the second optic is configured to form negative components of the derivative kernel.

3. The method of claim 2, wherein the derivative kernel is a Laplacian kernel.

4. The method of claim 1, wherein the metasurface comprises a plurality of sub-wavelength structures.

5. The method of claim 4, further comprising optimizing the plurality of sub-wavelength structures using an inverse design process.

6. The method of claim 1, further comprising inputting the feature-encoded image into an artificial neural network (ANN).

7. The method of claim 6, wherein the ANN is a deep neural network.

8. The method of claim 1, wherein imaging the object comprises capturing incoherent radiation reflected from or emitted by the object.

9. The method of claim 8, wherein the incoherent radiation is in the long-wave infrared (LWIR) band.

10. An optical edge detection system comprising:
a first optic comprising a first refractive lens;
a second optic comprising a second refractive lens and a metasurface;
an imaging device configured to capture a first image through the first optic and a second image through the second optic;
at least one processor operably coupled to the imaging device; and
at least one memory operably coupled to the at least one processor, the at least one memory having computer-executable instructions stored thereon that, when executed by the at least one processor, cause the at least one processor to:
receive, from the imaging device, the first image and the second image; and
subtract the first image and the second image to obtain a feature-encoded image.

11. The system of claim 10, wherein the first optic is configured to form positive components of a derivative kernel, and wherein the second optic is configured to form negative components of the derivative kernel.

12. The system of claim 11, wherein the derivative kernel is a Laplacian kernel.

13. A method for optical edge detection comprising:
imaging an object through an optic to obtain a plurality of images, wherein the optic comprises a refractive lens and a metasurface configured for polarization multiplexing, wherein the optic is configured to form positive components and negative components of a derivative kernel; and
subtracting a first image and a second image of the plurality of images to obtain a feature-encoded image.

14. The method of claim 13, wherein the derivative kernel is a Laplacian kernel.

15. The method of claim 13, wherein the plurality of images are obtained simultaneously.

16. The method of claim 13, wherein the metasurface comprises a plurality of sub-wavelength structures.

17. The method of claim 16, further comprising optimizing the plurality of sub-wavelength structures using an inverse design process.

18. The method of claim 13, wherein imaging the object comprises capturing incoherent radiation reflected from or emitted by the object.

19. The method of claim 18, wherein the incoherent radiation is in the long-wave infrared (LWIR) band.

20. The method of claim 13, further comprising inputting the feature-encoded image into an artificial neural network (ANN).

21. An optical edge detection system comprising:
an optic comprising a refractive lens and a metasurface configured for polarization multiplexing, wherein the optic is configured to form positive components and negative components of a derivative kernel;
an imaging device configured to capture a plurality of images through the optic;
at least one processor operably coupled to the imaging device; and
at least one memory operably coupled to the at least one processor, the at least one memory having computer-executable instructions stored thereon that, when executed by the at least one processor, cause the at least one processor to:
receive, from the imaging device, the plurality of images; and
subtract a first image and a second image of the plurality of images to obtain a feature-encoded image.

22. The system of claim 21, wherein the derivative kernel is a Laplacian kernel.

23. The system of claim 21, wherein the imaging device is a polarimetry-enabled device.
